(19) United States
(12) Patent Application Publication
(10) Pub. No.: US 2002/0144788 A1
(43) Pub. Date: Oct. 10, 2002

(54) Automatic applicator for non-adhesive labels

(76) Inventors: Frederick John Shortt, Reggio Emilia (IT); Athos Claudio Mattioli, Scandiano (IT)

Correspondence Address: MODIANO & ASSOCIATI, Via Meravigli, 16, Milano, 20123, IT

(21) Appl. No.: 10/109,866

(22) Filed: Apr. 1, 2002

(30) Foreign Application Priority Data
Apr. 6, 2001 (IT) RE2001A000037

(51) Int. Cl. B32B 31/00

(52) U.S. Cl. 156/350; 156/556

(57) ABSTRACT

The device for automatic application of non-adhesive labels to a stack of products, particularly flat products, box-like products or the like, comprises a structure for supporting an arm slideable along a first direction, substantially parallel to its axis, and along a second direction, substantially perpendicular to its axis; a head articulated to the arm is provided with suckers for gripping a label to be applied to the stack, with separators for the products which are adapted to lift them at at least a stack level to create a space for insertion of a flap of the label, and with insertion elements for the flap in the provided space.

### BACKGROUND OF THE INVENTION

The present invention relates to an automatic device for applying non-adhesive labels to stacks of superimposed products, particularly flat products, box-like products, or the like.

It is known that many products having flat surfaces, such as cardboards for forming packaging and small and/or large boxes, planks of plywood and/or the like, plastic or hardboard panels, box-like products or the like are normally handled on rollers or conveyor belts, with or without a pallet, are stacked on each other in more or less bulky groups. The groups are then packaged by means of strap applications, coverings with plastic protection, wrapping with heat-shrink films and so forth, in order to facilitate handling, storage and transportation thereof.

It is also known that these packagings are usually provided with informational labels bearing the characteristics of the packaged products, general information and possibly bar codes.

For this purpose, the labels must be applied accurately, so as to adhere to the packagings, in order to avoid tearing thereof during handling, and to allow correct automatic reading operations.

Currently, labeling operations are performed by gluing and/or manual insertion, with obvious operating difficulties, inaccurate positioning, slowing of continuous cycles, thus with additional labor and accordingly with an increase in production costs.

### SUMMARY OF THE INVENTION

The aim of the present invention is to eliminate the above cited drawbacks by providing an automatic applicator for non-adhesive labels that allows to obtain the following results and advantages: the operations for placing the labels, applying them and coupling them in alignment are performed entirely automatically, without the need of specifically assigned personnel and with the assurance of achieving perfectly uniform placements on one or more exposed sides of the packages before final packaging.

This aim and other objects that will become better apparent hereinafter are achieved by the present automatic applicator for non-adhesive labels, characterized in that it comprises a structure for supporting an arm to which a head is articulated, said head being provided with sucker-fitted means for gripping a label to be applied to a stack of products, particularly flat, box-like or similar products, with separating means for separating said products which are adapted to lift the products at at least a level of the stack in order to create a space for the insertion of a flap of said label, and with means for inserting said flap in said space.

### BRIEF DESCRIPTION OF THE DRAWINGS

Further characteristics and advantages of the present invention will become better apparent from the detailed description of a preferred but not exclusive embodiment of an automatic applicator for non-adhesive labels, illustrated only by way of non-limitative example in the accompanying drawings, wherein:

FIG. 1 is a general schematic side view of the applicator according to the invention;

FIG. 2 is a schematic enlarged-scale side view, showing only the head of the applicator according to the invention, with sucker-fitted grip means engaging the labels and lamina-type separator means, which are independent and on different levels, during the opening of spaces between the products of a stack to be labeled, in order to insert the flaps of the labels;

FIG. 3 is a schematic side view of the sucker-fitted grip means associated with blade-type insertion means of the applicator according to the invention during operation;

FIG. 4 is a schematic enlarged-scale plan view of the head of the applicator of FIG. 1;

FIG. 5 is a schematic enlarged-scale side view of a first alternative embodiment of the head of the applicator according to the invention, with the sucker-fitted grip means during engagement of a label, needle- and wedge-type separator means, and blade-type insertion means operating at one level of a stack;

FIG. 6 is a schematic plan view of FIG. 5;

FIG. 7 is a schematic view of the head of FIG. 5, during the opening of a space between the products of the stack for the insertion of a flap of the label;

FIG. 8 is an enlarged-scale schematic side view of a detail of a second alternative embodiment of the head of the applicator according to the invention, with wedge-type separator means and blade-type insertion means;

FIG. 9 is a schematic view of the head of FIG. 8 during the opening of a space between the products of the stack;

FIG. 10 is a schematic view of the head of FIG. 8 during the insertion of a flap of a label in the space formed between the products of the stack;

FIG. 11 is a schematic view of the head of FIG. 8 during movement away from the stack after applying the label thereto.

### DESCRIPTION OF THE PREFERRED EMBODIMENTS

With reference to the figures, the automatic applicator for non-adhesive labels is substantially constituted by a structure S that comprises a post 1, which can be preset for fixed stations with a supporting base 2 to be rigidly coupled to the ground or can be provided on a movable base for different placements. Vertical guides 3 are arranged on the post 1, and the supporting wheels 4 of a motorized carriage 5 can slide on said guides; by means of an upper gearmotor 6 and driving elements, such as belts or chains 7 coupled to pulleys or sprockets 8, said carriage can be positioned in the chosen point along said post 1.

In turn, the carriage 5 has guiding wheels 9 on which a movable arm 10 slides horizontally; said arm comprises a chain or rack 11, which is coupled to the transmission gear 12 of a gearmotor 13 applied to said carriage.

The arm 10 can therefore move by sliding along a first direction A, which is substantially parallel to its own horizontal axis, and along a second direction B. which is substantially perpendicular to its own vertical axis and is formed by the post 1.

A head 14 is articulated to the front end of the arm 10.

The head 14 is pivoted to the front end of the arm 10 about a first fulcrum 15 and is associated with a respective first cylinder 16 and with means of the rack-and-pinion type R for converting the reciprocating rectilinear motion of the piston of the first cylinder 16 into a rotary motion about the first fulcrum 15; by rotating about the first fulcrum 15, the head 14 can assume a vertical configuration for picking up the label to be applied and a horizontal configuration for applying the picked-up label.

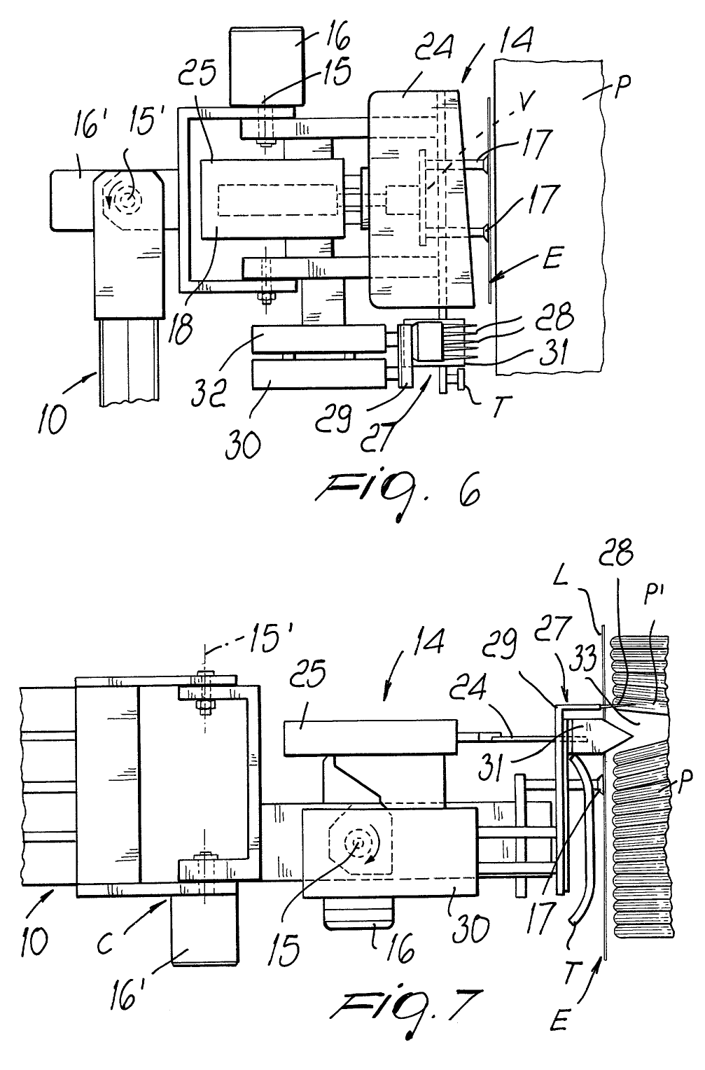

The head 14 can also be pivoted about a second fulcrum 15′ and be associated with a respective second rotary cylinder 16′ and with means C for converting the reciprocating rectilinear motion of the piston of the second cylinder 16′ into a rotary motion about the second fulcrum 15′ (FIGS. 5-7); by rotating about the second fulcrum 15′, the head 14 can assume a first configuration for applying a label, in which it is aligned with the arm 10 (FIG. 5), and a second configuration for applying a label, in which it is orientated transversely to the arm 10 (FIG. 6); this allows to apply labels to planes that form an angle of 90° with respect to each other.

The head 14 is provided with sucker-fitted means 17 for gripping a label E to be applied to a stack of products P, particularly flat products, box-like products or the like; the sucker-fitted grip means 17 are associated with a suction assembly V and with a respective hydraulic or pneumatic actuator, constituted by a central cylinder 18 adapted to move them toward and away from the stack.

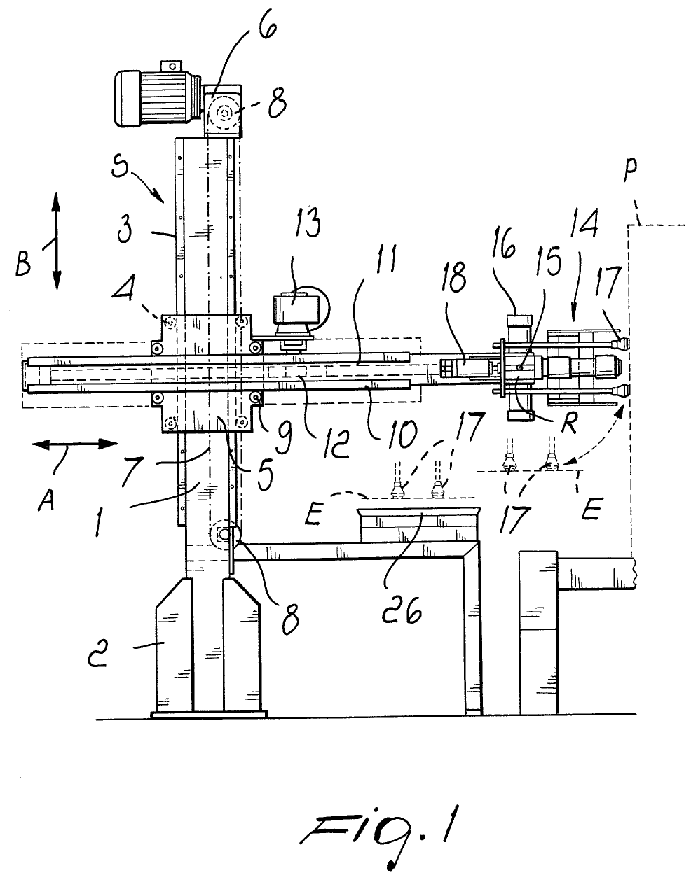

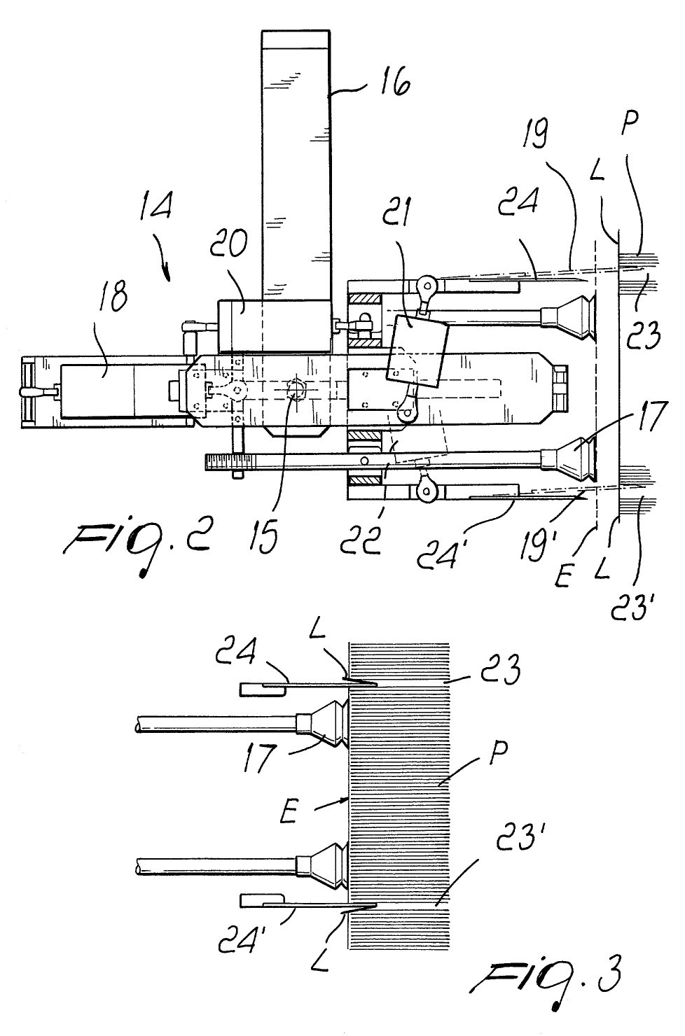

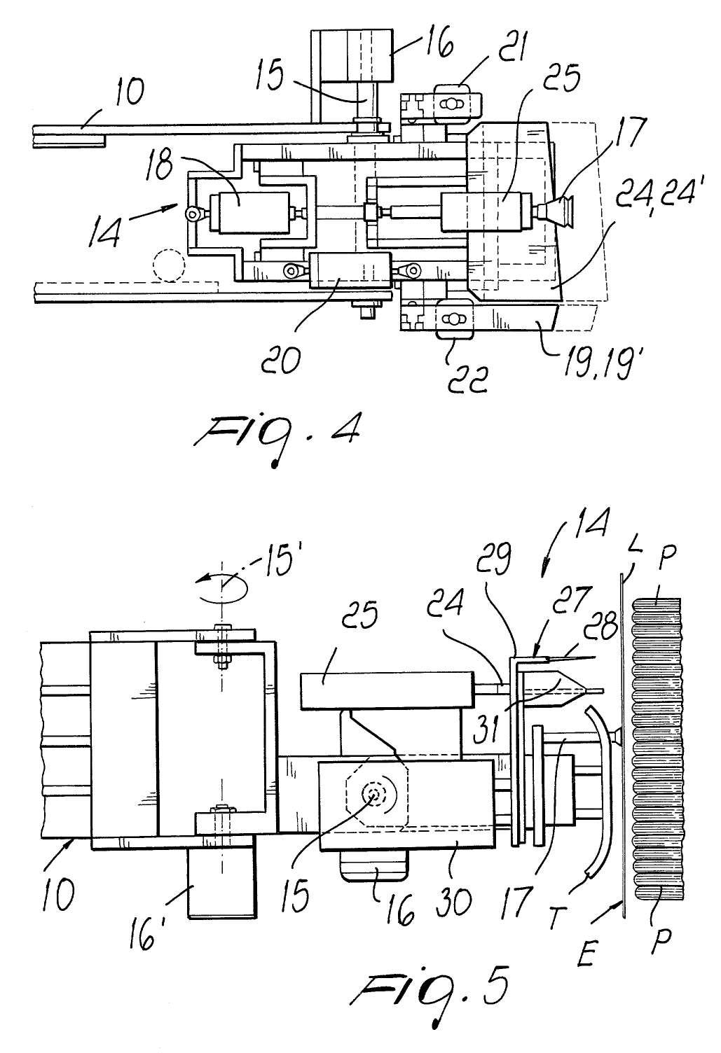

The head 14 is further provided with means for separating the products P, which are adapted to lift them at at least a level of the stack in order to form a space for inserting a flap L of the label E; in the embodiment shown in FIGS. 1 to 4, said separator means are constituted by two laminas 19 and 19′, which are arranged at the different levels, are actuated by a lateral cylinder 20, and are associated with other cylinders 21 and 22, which actuate in vertical movement 23 and 23′ the laminas for the differentiated local lifting of the products P.

The head 14 is further provided with means for inserting the flap L of the label E in the space formed by the separator means, which are constituted by at least one blade 24 which is arranged substantially parallel to the surfaces of the products P in mutual contact and is associated with a respective hydraulic or pneumatic actuator, constituted by a cylinder 25 which is rigidly associated with the head 14 and is adapted to move the blade 24 toward and away from the stack for the insertion of the flap L of the label E in the space formed between the products P.

In the embodiment shown in FIGS. 1 to 4, the insertion means comprise two blades 24 and 24′ arranged at different levels proximate to the laminas 19 and 19′.

During operation, the head 14 is orientated vertically with respect to a container 26 of labels E, which are individual and stacked or provided on continuous stock, picks up one label at a time by means of the suckers 17, rotates about the first fulcrum 15 until it is orientated horizontally, advances until the lamina-type separator means 19 and 19′ are in a condition for the differentiated local lifting of the stacked products P (the lifting 23 produced by the upper separator 19 is twice the lifting 23′ produced by the lower separator 19′ in order to take into account the thickness of the stacked material comprised between them), and rests and stops the suckers 17 that support the label E against the stacked products P; then the insertion blades 24 and 24′ push the flaps L of the label E between the lifted products P, the laminas 19 and 19′ and the blades 24 and 24′ retract, and the flaps L of the label E remain trapped between the spaces 23 and 23′, which close due to the overlying weight of said stacked products P themselves; then the suckers 17 separate and the arm 10 retracts, ready for a subsequent operating cycle.

Lifting and insertion can also be performed with a single separation lamina 19 and with a single insertion blade 24 on the upper flap L of the label E, where the flap can be pushed into the space 23 fully or partially so as to fold back onto itself.

This embodiment entails deactivating or eliminating one separation lamina 19′ and one insertion blade 24′ with the corresponding actuation means.

Partial insertion with folded flaps or full insertion with straight flaps is also possible by adopting the two separation laminas 19 and 19′ and the two insertion blades 24 and 24′.

In the first alternative embodiment, shown in FIGS. 5 to 7, the means for separating the products P comprise a pointed element, constituted by a fork 27 provided with a plurality of needles 28 for gripping a product P of the stack.

The fork 27 is fixed to a support 29, which is associated with the stem of a respective hydraulic or pneumatic actuator constituted by a first pneumatic cylinder 30, which is jointly associated with the head 14 and is adapted to move the fork 27 toward and away from the stack of products P.

The separator means further comprise a wedge-like element, constituted by a wedge 31 which is jointly coupled to the stem of a respective hydraulic or pneumatic actuator constituted by a second pneumatic cylinder 32; the second pneumatic cylinder 32 is jointly associated with the head 14 and is adapted to move the wedge 31 toward and away from the stack in order to insert it between two successive products P, forming between them a space 33 for the insertion of a flap L of the label E.

Once the label E has been picked up and positioned proximate to the stack of products P, the first pneumatic cylinder 30 moves the fork 27 toward the stack, so that the needles 28 pierce a product P′; by actuating the gearmotor 6, the carriage 5 and therefore the arm 10 and the head 14 are moved upward in order to lift the product P′ with respect to the underlying products, forming between them a space of predefined extent which can be controlled by means of adapted detection means, not shown, which cooperate with said gearmotor 6.

The reference letter T designates a probe that determines the position of the products P and the corresponding stopping of the head 14.

Once the gearmotor 6 has stopped, the second pneumatic cylinder 32 moves the wedge 31 toward the stack, inserting it between the product P′ and the underlying products P, forming the space 33 between them.

The blade 24 is moved by the cylinder 25 toward the stack in order to insert the upper flap L of the label E in the space 33; then the first pneumatic cylinder 30 with the fork 27, the second pneumatic cylinder 32 with the wedge 31 and the cylinder 25 with the lamina 24 retract; finally, the suckers 17 release the label E thus applied.

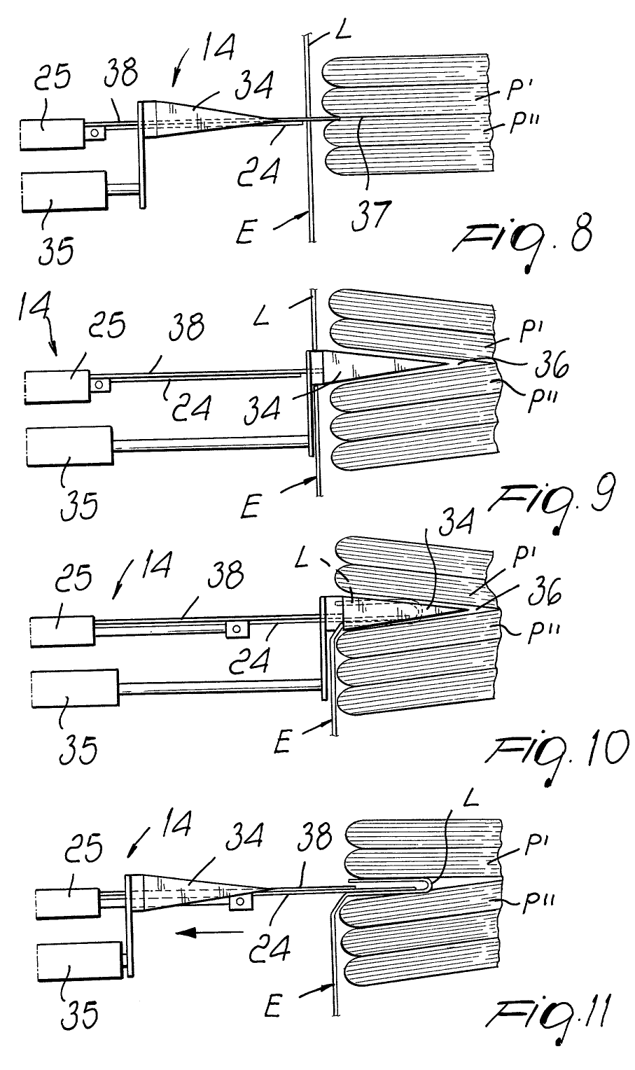

In the second alternative embodiment, shown schematically in FIGS. 8 to 11, the head 14 is provided with separator means constituted by a single wedge 34 which is rigidly coupled to the stem of a respective pneumatic cylinder 35, which is rigidly associated with the head 14 and is adapted to move the wedge 34 toward and away from the stack in order to insert it between two successive products P′ and P″, particularly boxes, forming between them a space 36 for the insertion of a flap L of the label E.

In this second alternative embodiment, the applicator according to the invention further comprises means for detecting the separation line 37 between two successive products P′ and P″ of the stack, said means cooperating with the separator means and being constituted by a laser beam 38 or by a photocell or by an electromechanical probe, or the like.

After positioning the label E proximate to a stack of products P, by making the carriage 5 slide along the post 1, the arm 10 and, therefore, the head 14 scan the stack until the laser 38, or other alternative detection means, detects a line 37.

At this point, after locking the gearmotor 6 so that the wedge 34 and the blade 24 are aligned with the line 37, the pneumatic cylinder 35 moves the wedge 34 toward the stack, inserting it between the products P′ and P″ separated by the line 37, forming the space 36 between them; then the cylinder 25 moves the blade 24 toward the stack in order to insert the flap L of the label E in the space 36.

Once insertion has ended, the pneumatic cylinder 35 with the wedge 34 and the cylinder 25 with the blade 24 retract in succession.

The applicator operates at one level at a time; by moving the arm 10 along the post 1 it is possible to operate at a different level, for example at a lower level than the first one in order to also insert the lower flap of the label E, repeating cyclically the above described operations.

The applicator allows to insert the flap L so that it is flat or folded onto itself in a U-like shape.

All the movements are programmable by means of a dedicated computer.

In practice it has been found that the described invention achieves the is intended aim and objects.

The invention thus conceived is susceptible of numerous modifications and variations, all of which are within the scope of the appended claims.

All the details may further be replaced with other technically equivalent ones.

In practice, the materials used, as well as the shapes and the dimensions, may be any according to requirements without thereby abandoning the scope of the protection of the appended claims.

The disclosures in Italian Patent Application No. RE2001A000037 from which this application claims priority are incorporated herein by reference.

What is claimed is:

1. An automatic applicator for applying non-adhesive labels to a stack of products, comprising: a supporting structure; an arm supported at said structure; a head articulated at said arm; sucker-fitted means provided at said head for gripping a label to be applied to a stack of products, which generally have a flat, box-like configuration; separating means provided at said head for separating said products, said separating means being actuatable to lift said products at at least a level reached by the stack in order to create a space for insertion of a flap of said label; and inserting means provided at said head for inserting said flap in said space.

2. The applicator of claim 1, wherein said arm extends along an axis thereof and is supported at said structure so as to be movable by sliding along a first direction, which is substantially parallel to said axis, and along a second direction, which is substantially perpendicular to said axis.

3. The applicator of claim 2, further comprising a post, which extends along said second direction; a motorized carriage which is slideable along said post, said arm slideable along said first direction being associated with said carriage, and said post being supported at a base of said supporting structure.

4. The applicator of claim 3, wherein said head is pivoted, at one end of said arm, about a first fulcrum; and being provided with a respective first cylinder having a piston thereof, and with motion converting means for converting reciprocating rectilinear motion of the piston of said first cylinder into a rotary motion about said first fulcrum, said head being actuatable to rotate about said first fulcrum between a configuration for picking up the label to be applied, in which the label is orientated vertically, and a configuration for applying the picked-up label, in which the label is orientated horizontally.

5. The applicator of claim 4, wherein said head is pivoted to the end of said arm about a second fulcrum and is provided with a respective second rotary cylinder with a piston thereof and with motion converting means for converting reciprocating rectilinear motion of the piston of said second cylinder into a rotary motion about said second fulcrum, said head being actuatable to rotate about said second fulcrum between a first configuration for applying a label, in which the label is aligned with said arm, and a second configuration for applying a label, in which the label is orientated transversely to said arm.

6. The applicator of claim 1, further comprising a suction assembly and a respective actuator of any of the hydraulic and pneumatic type, which is connected to and adapted to move said sucker-fitted grip means toward and away from said stack.

7. The applicator of claim 3, wherein said separator means comprise at least one lamina, a lateral cylinder and a respective actuation cylinder for actuation thereof for vertical movements for the local lifting of the products.

8. The applicator of claim 3, wherein said separator means comprise a pointed element for gripping a product of said stack; a respective actuator of any of a hydraulic and pneumatic type which is jointly associated with said head and is arranged so as to move said pointed element toward and away from said stack, the product engaged by said pointed element being lifted from underlying products as a consequence of a presettable sliding of said arm along said second direction.

9. The applicator of claim 8, wherein said pointed element further comprises a fork provided with a plurality of needles.

10. The applicator of claim 7, wherein said separator means comprise detection means for detecting an extent of lifting of said engaged product with respect to underlying products that cooperate with said motorized carriage.

11. The applicator of claim 3, wherein said separator means comprise at least one wedge-like element, and a respective actuator of any of a hydraulic and pneumatic type which is jointly associated with said head and is adapted to move said element toward and away from said stack, said wedge-shaped element being adapted to be inserted between two successive products of said stack in order to create said insertion space between the products.

12. The applicator of claim 7, further comprising detection means for detecting a separation line between two successive products of said stack, said detection means cooperating with said separator means.

13. The applicator of claim 12, wherein said detection means for detecting the separation line comprises any of a laser beam, a photocell, and an electromechanical probe.

14. The applicator of claim 7, wherein said insertion means comprise at least one blade which is arranged substantially parallel to surfaces of the products of said stack that are in mutual contact, and a respective actuator of any of a hydraulic and pneumatic type, which is jointly associated with said head and is adapted to move said blade toward and away from said stack for insertion of said flap in said space.

15. The applicator of claim 14, comprising two said laminas arranged at two different levels and two said blades arranged at said two different levels for insertion of two, upper and lower, flaps of said label in respective spaces.
